(19) United States
(12) Patent Application Publication
(10) Pub. No.: US 2006/0233606 A1
(43) Pub. Date: Oct. 19, 2006

(54) Fastener arrangement for fastening a detachable panel

(75) Inventors: Phillip Vincent Teague, Bristol (GB); John Lemuel Watson, Bristol (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems plc, London (GB)

(21) Appl. No.: 11/171,265

(22) Filed: Jul. 1, 2005

(30) Foreign Application Priority Data
Jul. 9, 2004 (GB) 0415398.7

(51) Int. Cl. F16D 1/00

(52) U.S. Cl. 403/408.1

(57) ABSTRACT

The invention relates to a fastener for attaching detachable panels to a support structure, in particular for use in aerospace applications. The fastener comprises a first tapered portion and a second tapered portion, each of the tapered portions having a thinner end and a thicker end, the first and second tapered portions being located axially adjacent each other such that the thicker end of the first tapered portion is located axially adjacent the thicker end of the second tapered portion, and wherein the angle of taper of the first portion is greater than the angle of taper of the second portion. An assembly is also described, comprising a fastener, a support structure and a detachable panel.

The invention relates to fastening a detachable panel and is particularly, but not exclusively, concerned with the fastening of a detachable load bearing panel to the supporting structure of an aircraft.

Panels on an aircraft, such as engine cover panels, need to be detached at times for access to working parts of the aircraft. Large panels can often be fastened down by a multiplicity of fasteners. Whilst removal of the fasteners for detachment of the panel is usually not too difficult, re-alignment of the panel, during refitting, to clear the fasteners protruding from the supporting structure can sometimes be a problem where large numbers of fasteners are involved.

It is known to attach a panel to an aircraft structure using a multiplicity of fasteners, e.g. studs attached to the structure and which project out of the structure for location in fixing holes in the panel. Once located in the panel, nuts are screwed on to the studs to hold the panel in place. Detachment of the panel is not difficult with such an arrangement but re-location of the panel can be difficult as it is necessary to align the studs with the large number of holes in the panel. Another problem with such an arrangement can arise during the initial installation of the studs where it is necessary to ensure that all the studs are precisely parallel with each other. This can be quite difficult to achieve where the panel and structure have compound curvatures, and can require the use of expensive tooling to ensure that the studs are installed correctly.

An object of the present invention is to provide a fastening which will help to overcome the problems outlined in the immediately preceding paragraph and which may also be useful in other applications where detachable fastening of panels is involved. Examples of such other applications include the detachable fastening of non-load bearing panels, such as interior panels within an aircraft.

According to a first aspect of the invention there is provided a fastener comprising a first tapered portion and a second tapered portion, each of the tapered portions having a thinner end and a thicker end, the first and second tapered portions being located axially adjacent each other such that the thicker end of the first tapered portion is located axially adjacent the thicker end of the second tapered portion, and wherein the angle of taper of the first portion is greater than the angle of taper of the second portion.

The first tapered portion is preferably of a non-jamming type, for example having an angle of taper greater than around 5 degrees. The second tapered portion is preferably of a jamming type, for example having an angle of taper less than around 5 degrees. Advantageously, the first tapered portion has an angle of taper in the range 15-40 degrees.

The fastener may further comprise two screw threaded portions, one screw threaded portion being located axially adjacent the thinner end of the first tapered portion, and the other screw threaded portion being located axially adjacent the thinner end of the second tapered portion.

This invention is advantageous over the prior art as it allows one tapered portion of the fastener to be permanently fixed in position in a supporting structure to which a panel is to be attached, whilst allowing the panel to be removably fitted to the other tapered portion.

According to a second aspect of the invention there is provided an assembly comprising a fastener, a panel and a supporting structure to which the panel is detachably fastened by the fastener, the panel and supporting structure being formed with tapered holes which receive the fastener, the fastener comprising a first tapered portion for location in the panel, and a second tapered portion for location in the supporting structure, each of the tapered portions having a thinner end and a thicker end, the first and second tapered portions of the fastener being located axially adjacent each other such that the thicker end of the first tapered portion is located axially adjacent the thicker end of the second tapered portion, and wherein the angle of taper of the first portion and its corresponding hole in the panel is greater than the angle of taper of the second portion and its corresponding hole in the supporting structure.

The first tapered portion of the fastener is preferably of a non-jamming type, for example having an angle of taper greater than around 5 degrees. The second tapered portion of the fastener is preferably of a jamming type, for example having an angle of taper less than around 5 degrees. Advantageously the first tapered portion has an angle of taper in the range 15-40 degrees.

The fastener may further comprise two screw threaded portions, one screw threaded portion being located axially adjacent the thinner end of the first tapered portion, and the other screw threaded portion being located axially adjacent the thinner end of the second tapered portion. A standard high tension nut may be used to retain the panel on the supporting structure, and a similar nut may be used, if desired, to aid retention of the fastener in the support structure.

This arrangement provides advantages over the prior art as it allows the joint to be disassembled more easily because the greater angle of taper of the first tapered portion of the fastener prevents the panel from becoming jammed on the fastener. The corresponding tapered hole in the panel allows a generous clearance hole in the mating surface of the panel, so that it is easier to align the holes in the panel with the fasteners when fitting a panel where a large number of fasteners are required. Furthermore, the first tapered portion of the fastener is urged against the correspondingly tapered hole of the panel to provide a joint capable of carrying shear loads. Also, the second tapered portion of the fastener has a small angle of taper which allows the second tapered portion to jam in the correspondingly tapered hole in the support structure so that it is not easily removable and so that it does not allow the fastener to rotate when the panel retaining nut is done up or undone.

For aerodynamic surfaces, for example, a cover may be provided over the panel so that the fastener does not project beyond an outer surface of the aerodynamic body and thus the fastener will not interfere with air flow over the aerodynamic body.

The tapered element may be of frusto-conical form.

Fastening of detachable panels will now be described by way of example with reference to the accompanying drawings in which:

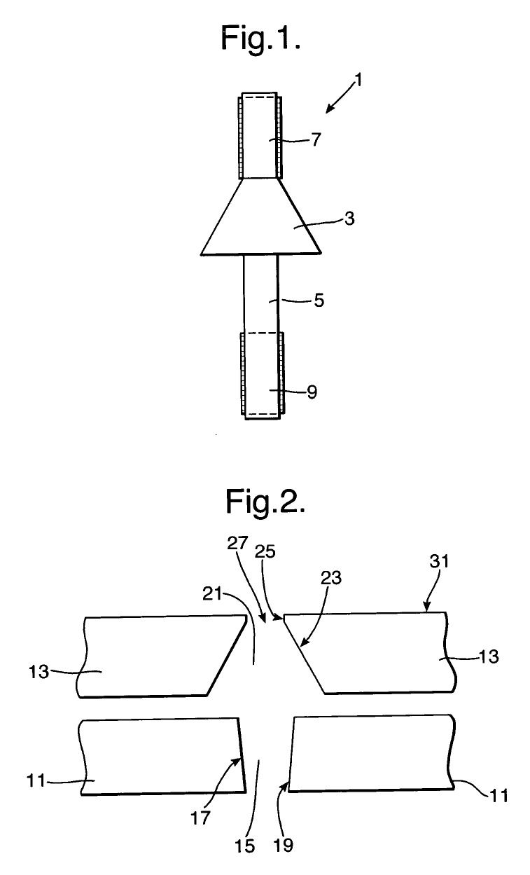

FIG. 1 is a cross-section through a fastener according to the present invention; and

FIG. 2 is an exploded cross-section through a supporting structure and a load-bearing panel which is to be attached to the supporting structure; and

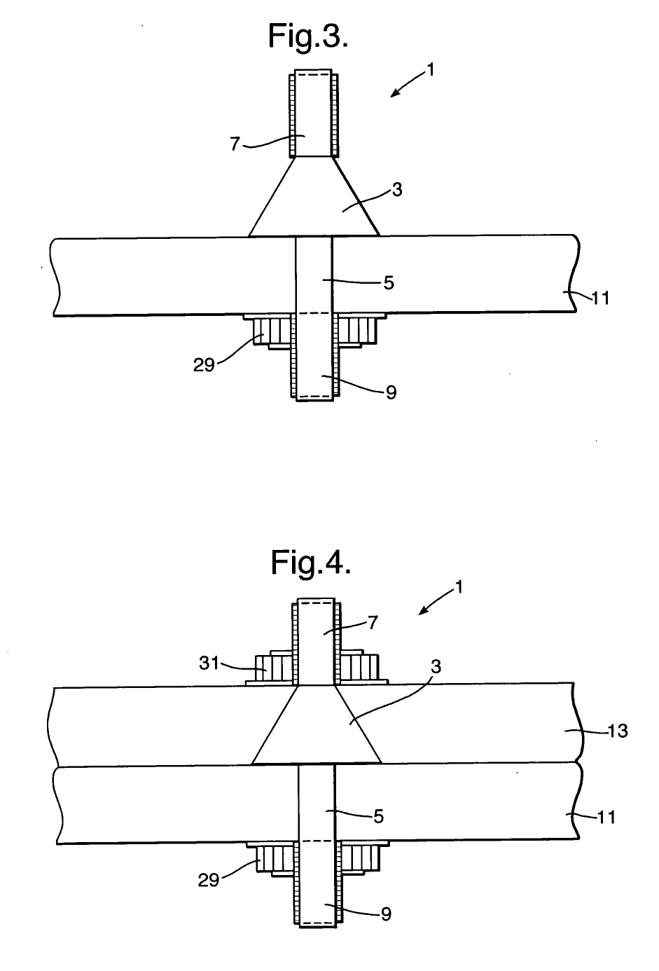

FIG. 3 is a cross-section through the fastener of FIG. 1 fixed in the supporting structure of FIG. 2; and

FIG. 4 is a cross-section through the fastener and supporting structure arrangement of FIG. 2 with a non-load-bearing panel detachably attached to the support structure by the fastener.

FIG. 1 shows a fastener 1 having a first tapered portion 3, a second tapered portion 5 and screw threaded portions 7 and 9. The portions 3, 5, 7, 9 are, in this example, integral, ie formed from one piece of metal or other suitable material, to provide a high degree of strength. The first tapered portion is designed to be non-jamming, and therefore should have an angle of taper no less than around 5 degrees. The greater the angle of taper, the worse generally the joint will be at transferring shear loads, but the easier the panel will be to attach. It is not recommended that the angle of taper exceed 45 degrees, and in this example an angle of taper of 25 degrees is used. The angle of taper will be partly dependent on the materials chosen for the supporting structure, fastener and panel.

The second tapered portion is designed to be jamming, ie to provide an interference fit with the corresponding hole in the supporting structure, and therefore should have an angle of taper of no more than around 5 degrees. In this example an angle of taper of 3 degrees is used. This tapered portion of the fastener is designed to prevent the fastener rotating under very high applied torques.

FIG. 2 shows a supporting structure 11 having a tapered hole 15 formed in it. The hole is of substantially frusto-conical shape and is defined by the tapered wall 17 of the support structure 11. The angle of taper of the wall 17 is substantially the same angle of taper as that of the second tapered portion 5 of the fastener, so that the hole 15 is able to receive the second tapered portion 5 of the fastener 1. The angle of taper of the wall 17 is designed to be of a jamming type, being, in this example, 3 degrees.

A panel 13 is also shown, the panel being designed to attach to the supporting structure 11. The panel 13 has a tapered hole 21 formed in it. The hole 21 is of substantially frusto-conical shape and is defined by the tapered wall 23 of the panel 13. The angle of taper of the wall 23 is substantially the same angle of taper as that of the first tapered portion 3 of the fastener 1, so that the hole 21 is able to receive the first tapered portion 3 of the fastener 1. The angle of taper of the wall 23 is designed to be of a non-jamming type, being, in this example, 25 degrees.

The tapered wall 23 of the panel 13 ends approximately 1 mm from the outer (non-mating) surface 31 of the panel 13. Instead, a cylindrical wall 25 of the panel which is substantially perpendicular to the surface 31 of the panel is formed, defining a cylindrical clearance hole 27. This prevents the panel 13 having a knife-edged area around the hole 21, as would be the case if the tapered walls 23 continued to the outer surface 31 of the panel. Such knife-edged areas are very weak, and could cresult in the panel being damaged during assembly or disassembly. The cylindrical wall 25 is not required to carry any load as the tapered wall 23 fulfils this function. A similar cylindrical wall 19 may, if desired, be provided in the substructure 11. This is less critical however, as the fastener 1 will generally be fitted permanently in the substructure.

For load-bearing panels, it is desirable that the length of the cylindrical wall 25 is kept to a minimum. This may be around 1 mm depending on the material used for the panel. This is to allow the maximum area for transmission of loads, which occur through the tapered wall 23. Where the panel is not designed to be load-bearing, the cylindrical wall 25 may extend much deeper into the panel, as the tapered wall 23 will not be required to bear loads, and will be useful primarily in locating the fastener in the panel.

FIG. 3 shows the fastener 1 attached to the supporting structure 11. The second tapered portion 5 of the fastener 1 is fitted into the correspondingly tapered hole 15 in the supporting structure 11. The taper is designed to give an interference fit between the second tapered portion 5 and the walls 17 of the supporting structure. This allows the second tapered portions to be jammed into the hole and prevents the fastener from rotating the hole 15. A high tension nut 29 is screwed onto the threaded portion 9 to further secure the fastener. In aircraft applications, the nut 29 may be inaccessible following assembly of the aircraft, and the fastener 1 is therefore permanently fixed to the supporting structure.

FIG. 4 shows the fastener 1 attached to the suporting structure 11 as previously described with reference to FIG. 3. A load-bearing detachable panel 13 has been mounted onto the fastener 1. The panel has a tapered hole 21 formed in it as described previously with respect to FIG. 2. In use, the supporting structure 11 has a large number of fasteners fixed to it, protruding as shown in FIG. 3. The panel 13 is large and has numerous tapered holes 21 for receiving the fasteners. The tapered holes 21 make it easier for the panel to be mounted onto the supporting structure, as the widest part of the hole receives the fastener. And then the tapered walls guide the fastener through the hole in the panel. As the tapered holes are much wider than the threaded portion of the fasteners, it is easier to align the fasteners with the holes than for the prior art, and there is less risk of the fasteners jamming due to angular misalignment. A standard high tension retaining nut 31 is screwed onto the threaded portion 7 to secure the panel in place. The first tapered portion 3 has a wide angle of 25° to prevent the joint from jamming and allow easy removal of the panel when the nut 31 is removed.

The shear load is transmitted across the joint via the first tapered portion 3 of the fastener 1 and the tapered walls 23 of the panel. Close tolerances are required on both the first tapered portion 3 and the tapered walls 23 in order to maintain a good shear carrying joint (max clearance should be about 0.002″).

The second tapered portion 5 is jammed into the tapered hole 15 in the support structure 11 as described previously with reference to FIG. 3. The interference of the tapered walls 17 on the second tapered portion 5 is sufficient to prevent the fastener 1 from rotating under very high applied torques, so that the nut 31 can be tightened and released without the fastener spinning, therefore the fastener 1 remains firmly secured to the support structure 11 whilst the panel retaining nut 31 can be installed and removed easily, allowing the panel 13 to be readily detached from and attached to the support structure 11.

1. A fastener comprising a first tapered portion and a second tapered portion, each of the tapered portions having a thinner end and a thicker end, the first and second tapered portions being located axially adjacent each other such that the thicker end of the first tapered portion is located axially adjacent the thicker end of the second tapered portion, and wherein the angle of taper of the first portion is greater than the angle of taper of the second portion.

2. A fastener as claimed in claim 1 wherein the first tapered portion is of a non-jamming type, having an angle of taper greater than 5 degrees.

3. A fastener as claimed in claim 1 wherein the second tapered portion is of a jamming type, having an angle of taper less than 5 degrees.

4. A fastener as claimed in claim 1 wherein the fastener comprises two screw threaded portions, one screw threaded portion being located axially adjacent the thinner end of the first tapered portion, and the other screw threaded portion being located axially adjacent the thinner end of the second tapered portion.

5. A fastener as claimed in claim 1 wherein the first tapered portion has an angle of taper in the range 15-40 degrees.

6. An assembly comprising a fastener, a panel and a supporting structure to which the panel is detachably fastened by the fastener, the panel and supporting structure being formed with tapered holes which receive the fastener, the fastener comprising a first tapered portion for location in the panel, and a second tapered portion for location in the supporting structure, each of the tapered portions having a thinner end and a thicker end, the first and second tapered portions of the fastener being located axially adjacent each other such that the thicker end of the first tapered portion is located axially adjacent the thicker end of the second tapered portion, and wherein the angle of taper of the first portion and its corresponding hole in the panel is greater than the angle of taper of the second portion and its corresponding hole in the supporting structure.

7. An assembly as claimed in claim 6 wherein the first tapered portion is of a nonjamming type, having an angle of taper greater than 5 degrees.

8. An assembly as claimed in claim 6 wherein the second tapered portion is of a jamming type, having an angle of taper less than 5 degrees.

9. An assembly as claimed in claim 6 wherein the fastener comprises two screw threaded portions, one screw threaded portion being located axially adjacent the thinner end of the first tapered portion, and the other screw threaded portion being located axially adjacent the thinner end of the second tapered portion.

10. An assembly as claimed in claim 6 wherein the first tapered portion has an angle of taper in the range 15-40 degrees.
